(19) United States
(12) Patent Application Publication
(10) Pub. No.: US 2015/0322539 A1
(43) Pub. Date: Nov. 12, 2015

(54) METHOD FOR ADJUSTING FURNACE ATMOSPHERE IN CONTINUOUS ANNEALING FURNACE (AS AMENDED)

(71) Applicant: JFE STEEL CORPORATION, Tokyo (JP)

(72) Inventors: Motoki Takada, Chiba (JP); Hideyuki Takahashi, Fukuyama (JP); Takamasa Fujil, Chiba (JP); Nobuyuki Sato, Chiba (JP)

(73) Assignee: JFE STEEL CORPORATION, Tokyo (JP)

(21) Appl. No.: 14/763,901

(22) PCT Filed: Jan. 28, 2013
(86) PCT No.: PCT/JP2013/000435

§ 371 Date: Jul. 28, 2015

(51) Int. Cl. C21D 9/56; C22C 38/00; F27D 7/06; C21D 1/76

(52) U.S. Cl. CPC C21D 9/561; C21D 1/76; C22C 38/00; F27D 7/06

(57) ABSTRACT

A problem with existing technologies that, when decreasing the dew point of the inside of a continuous annealing furnace by using a refiner, a decrease in the temperature of a part of the inside of the furnace cannot be prevented without supplying additional heat, is to be solved. Provided is a method for adjusting a furnace atmosphere in a continuous annealing furnace, the method including drawing a gas, which is a part of the furnace atmosphere, into a refiner 8 disposed outside the furnace and dehumidifying and deoxidizing the gas; causing the gas that has been dehumidified and deoxidized and that has exited the refiner 8 to exchange heat with a gas that is to be drawn into the refiner 8 in a heat exchanger 7 disposed outside the furnace; causing the gas to exchange heat with the furnace atmosphere in a furnace heat exchanger 11 disposed in the furnace; and reinjecting the gas into the furnace.

### TECHNICAL FIELD

The present invention relates to a method for adjusting a furnace atmosphere in a continuous annealing furnace. In particular, the present invention relates to a method for adjusting a furnace atmosphere in a continuous annealing furnace for the purpose of decreasing the dew point of a furnace atmosphere gas in a continuous annealing furnace and efficiently producing a steel sheet having good coatability.

### BACKGROUND ART

Regarding continuous annealing furnaces, which are used to continuously heat treat a steel sheet (more specifically, a band steel), it is known that the dew point of a furnace atmosphere gas is adjusted to be −45° C. or lower in order to improve the chemical conversion treatment property and the coatability of a high tensile steel sheet after heat treatment.

When starting up a continuous annealing furnace, the inside of the furnace is filled with the atmosphere gas, and the inside of the furnace and refractories in the wall of the furnace are permeated with water in the atmosphere gas. Such water is gradually removed as the furnace is operated. However, it is necessary to operate the furnace for dozen hours or several days so that the inside of the furnace can reach a dew point range in which a steel sheet can be produced. Performing such an operation is inefficient. The reason for this is that, it takes time for the dew point of the inside the furnace to decrease as water that has permeated into refractories is gradually supplied to the inside of the furnace after starting up the furnace. Patent Literature 1 describes a known example of a method for adjusting a furnace atmosphere. In this method, an atmosphere gas is directly supplied to the space in the furnace and, in addition, a low-temperature atmosphere gas having a temperature of 50° C. to 120° C. is injected into the space in the furnace from an outermost side of refractories in the wall of the furnace.

### Citation List

### Patent Literature

[PTL 1] Japanese Unexamined Patent Application Publication No. 07-173526

### SUMMARY OF INVENTION

### Technical Problem

In order to decrease the dew point of a furnace atmosphere in a continuous annealing furnace, it is necessary to draw a gas that is a part of a high-temperature furnace atmosphere into a refiner, which is a dehumidifying and deoxidizing apparatus; to dehumidify and deoxidize the gas; and when a method of injecting the gas into the furnace is used, to temporarily cool the high-temperature gas, which has been drawn into the refiner to be dehumidified and deoxidized, to a temperature near room temperature. If the gas that has been dehumidified and deoxidized and cooled to a temperature near room temperature were injected into the furnace, the temperature of the inside of the furnace would be excessively reduced and the quality of a steel sheet would be impaired. To prevent this, a method is used in which, before injecting the gas, which has been dehumidified and deoxidized and cooled to a temperature near room temperature, into the furnace, the temperature of the gas is increased by causing the gas to exchange heat with a high-temperature gas that has been drawn into the furnace.

However, by performing heat exchange between the high-temperature gas that has been drawn into the furnace and the gas that has been dehumidified and deoxidized and cooled to a temperature near room temperature, the temperature of the gas after the heat exchange is increased at most to a temperature that is about the mean of the temperatures of these gases. If the gas after the heat exchange, which has a temperature lower than the furnace temperature, were injected into the furnace, the temperature of a part of the furnace would be reduced. In order to prevent this, it is necessary to supply additional heat. In other words, existing technologies have a problem in that, when decreasing the dew point of the inside of a continuous annealing furnace by using a refiner, a decrease in the temperature of a part of the inside of the furnace cannot be prevented without supplying additional heat.

### Solution to Problem

The inventors performed close examination in order to solve the above problem. As a result, the inventors found that the decrease in the temperature of a part of the inside of the furnace can be prevented without supplying additional heat by increasing the temperature of the gas after the heat exchange by causing the gas to further exchange heat with the furnace atmosphere, thereby devising the present invention.

The present invention provides a method for adjusting a furnace atmosphere in a continuous annealing furnace, the method including drawing a gas, which is a part of the furnace atmosphere in the continuous annealing furnace, into a refiner disposed outside the furnace and dehumidifying and deoxidizing the gas in order to decrease a dew point of the furnace atmosphere; causing the gas that has been dehumidified and deoxidized and that has exited the refiner to exchange heat with a gas that is to be drawn into the refiner in a heat exchanger disposed outside the furnace; causing the gas to exchange heat with the furnace atmosphere in a furnace heat exchanger disposed in the furnace; and reinjecting the gas into the furnace.

### Advantageous Effects of Invention

According to the present invention, the temperature of a gas, which has been dehumidified and deoxidized by using a refiner, is increased by causing the gas to exchange heat with a gas to be drawn into the refiner by using a heat exchanger disposed outside the furnace; the temperature of the gas is further increased by causing the gas to exchange heat with a furnace atmosphere by using a furnace heat exchanger disposed in the furnace; and the gas is injected into the furnace. Therefore, the temperature of the gas injected into the furnace can be made closer to the temperature of the inside of the furnace without supplying additional heat. As a result, the dew point of the furnace atmosphere can be decreased while suppressing a decrease in the temperature of a part the furnace.

### BRIEF DESCRIPTION OF DRAWINGS

FIG. 1 is a schematic view illustrating an embodiment of the present invention.

### DESCRIPTION OF EMBODIMENTS

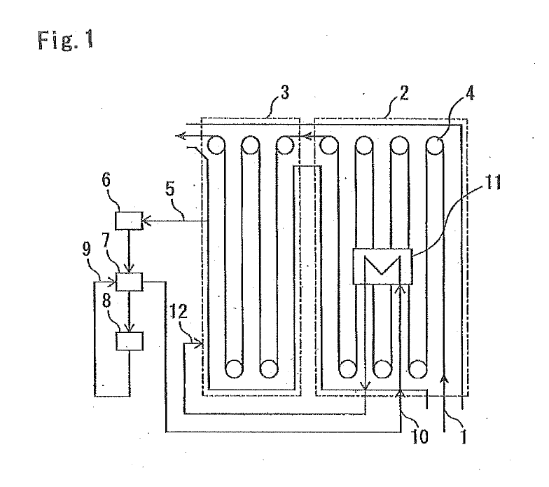

FIG. 1 is a schematic view illustrating an embodiment of the present invention. The FIG. 1 illustrates a steel sheet 1, a first heating zone 2 of an annealing furnace, a second heating zone 3 of the annealing furnace, rollers 4 in the furnace, draw-out piping 5, a blower 6, a heat exchanger 7, a refiner 8 (dehumidifying and deoxidizing apparatus), heat exchanger connection piping 9, heat exchanger supply piping in furnace 10, heat exchanger in furnace 11, and injection piping 12.

As illustrated in the FIGURE, the continuous annealing furnace is divided into the first heating zone 2 and the second heating zone 3. When the steel sheet 1 is continuously annealed in the annealing furnace while being conveyed by the rollers 4 in the furnace, a gas that is a part of the furnace atmosphere is drawn out from the second heating zone 3 through the draw-out piping 5. The gas that has been drawn out is sent by the blower 6 to the heat exchanger 7, and the gas is used as a hot heating medium of the heat exchanger 7. After the heat of the gas has been reduced due to heat exchange with a cold heating medium of the heat exchanger 7, the gas is supplied to the refiner 8. The gas is cooled to a temperature near room temperature in the refiner 8 and dehumidified and deoxidized. After exiting the refiner 8, the gas, which has a temperature near room temperature, flows through the heat exchanger connection piping 9, and the gas is used as a cold heating medium of the heat exchanger 7. The gas is heated due to heat exchange with the gas that has been drawn out, which is used as a hot heating medium of the heat exchanger 7. Thus, the temperature of the gas is increased to a temperature that is about the mean of the temperatures of these gases.

After exiting the heat exchanger 7, the gas flows through the heat exchanger supply piping in furnace 10 to the heat exchanger in furnace 11, and the gas is used as a cold heating medium of the heat exchanger in furnace 11. The heat exchanger in furnace 11 is disposed in the first heating zone 2, and the hot heating medium of the furnace heat exchanger 11 is the furnace atmosphere in the first heating zone 2. Accordingly, the gas that has exited the heat exchanger 7 is heated due to heat exchange with the furnace atmosphere in the heat exchanger in furnace 11. The temperature of the gas is increased to a temperature nearer to the temperature of the furnace atmosphere, and the gas is injected through the injection piping 12 into the second heating zone 3.

Preferably, in order to more effectively suppress a decrease in the temperature of a part of the furnace, the heat exchanger in furnace 11 is disposed, as in the present embodiment, at a position (in the present embodiment; the first heating zone 2) that is away from an injection position (in the present embodiment, the second heating zone 3) and at which a slight decrease in the temperature of the furnace would not cause a problem, that is, at which the furnace has a sufficient heating ability.

### Example

As an example according to the present invention, in FIG. 1, the burners of the first heating zone 2 and the second heating zone 3 were respectively operated under constant loads, and the furnace temperature was set at 800° C. Under such conditions, the flow rate of a gas treated by the refiner 8 (=injection flow rate) was set at 200 Nm³/hour, and the gas was injected along the gas flow path shown in FIG. 1. The temperature of the gas immediately before being injected (referred to as the “injection gas temperature”) and the furnace temperature in the second heating zone 3 after injection of the gas (referred to as the “post-injection second heating zone temperature”) were measured. As a comparative example, in FIG. 1, the heat exchanger in furnace 11 was not used, and the gas heated by the heat exchanger 7 was directly injected into the second heating zone 3. In other respects, the comparative example was the same as the example according to the present invention, and the same measurement was performed. Table 1 shows the results.

As can be seen from Table 1, in the example according to the present invention, the injection gas temperature was considerably higher than that of the comparative example, the post-injection furnace temperature in the second heating zone 3 was considerably higher than that of the comparative example, and a decrease of temperature from the set furnace temperature (800° C.) could be reduced considerably.

TABLE 1

| | | | Injection | Post-injection | |
|---|---|---|---|---|---|
| | | Injection | Gas Tem- | Second Heating | |
| | | Flow Rate | perature | Zone Tem- | |
| No. | Conditions | [Nm³/hour] | [° C.] | perature [° C.] | Remark |
| 1 | Furnace | 200 | 716 | 752 | Inven- |
| | Heat | | | | tion |
| | Exchanger | | | | Example |
| | Used | | | | |
| 2 | Furnace | 200 | 500 | 639 | Compar- |
| | Heat | | | | ative |
| | Exchanger | | | | Example |
| | Not Used | | | | |

### REFERENCE SIGNS LIST

1 steel sheet (more specifically, strip steel)
2 first heating zone of annealing furnace
3 second heating zone of annealing furnace
4 roller in a furnace
5 draw-out piping
6 blower
7 heat exchanger
8 refiner (dehumidifying and deoxidizing apparatus)
9 heat exchanger connection piping
10 heat exchanger supply piping in furnace
11 heat exchanger in furnace
12 injection piping

1. A method for adjusting a furnace atmosphere in a continuous annealing furnace, the method comprising drawing a gas, which is a part of the furnace atmosphere in the continuous annealing furnace, into a refiner disposed outside the furnace and dehumidifying and deoxidizing the gas in order to decrease a dew point of the furnace atmosphere; causing the gas that has been dehumidified and deoxidized and that has exited the refiner to exchange heat with a gas that is to be drawn into the refiner in a heat exchanger disposed outside the furnace; causing the gas to exchange heat with the furnace atmosphere in a furnace heat exchanger disposed in the furnace; and reinjecting the gas into the furnace.
